(19) United States
(12) Patent Application Publication
(10) Pub. No.: US 2022/0250848 A1
(43) Pub. Date: Aug. 11, 2022

(54) BELT CONVEYOR DEVICE WITH DEFLECTING ROLLER

(71) Applicant: FRITSCH BAKERY TECHNOLOGIES GMBH & CO. KG, Markt Einersheim (DE)

(72) Inventor: Fred DORNER, Kitzingen (DE)

(73) Assignee: FRITSCH BAKERY TECHNOLOGIES GMBH & CO. KG, Markt Einersheim (DE)

(21) Appl. No.: 17/668,851

(22) Filed: Feb. 10, 2022

(30) Foreign Application Priority Data
Feb. 10, 2021 (DE) 102021103122.2

(51) Int. Cl. B65G 15/60; B65G 39/18; B65G 15/28

(52) U.S. Cl. CPC B65G 15/60; B65G 2201/0202; B65G 15/28; B65G 39/18

(57) ABSTRACT

A belt conveyor device for conveying food products includes a frame, a conveyor belt and a drive device configured to drive the conveyor belt. The drive device includes a drive roller configured to drive the conveyor belt, a first deflecting roller configured to guide the conveyor belt, a second deflecting roller configured to guide the conveyor belt, and a first locking device configured to secure the first deflecting roller in an operating position, and a first engagement guard configured to cover a first gap between the first deflecting roller and the conveyor belt when the first locking device secures the first deflecting roller in the operating position.

### CROSS-REFERENCE TO RELATED APPLICATIONS

This application claims foreign priority benefits under 35 U.S.C. § 119(a)-(d) to German patent application number DE 102021103122.2, filed Feb. 10, 2021, which is incorporated by reference in its entirety.

### TECHNICAL FIELD

The disclosure relates to a belt conveyor device for conveying food products, in particular dough.

### BACKGROUND

Belt conveyor devices for conveying food products must meet high hygiene requirements. To this end, it is important that they be thoroughly cleaned on a regular basis. Among other things, thorough cleaning requires that components that come into direct or indirect contact with the conveyed products be accessible to cleaning personnel. During operation, however, some areas must not be accessible to people, as they would otherwise be exposed to a risk of injury. Conventional devices therefore often provide covers or casing for such areas. On the one hand, these may result in time-consuming cleaning breaks, as they have to be dismantled and reassembled at great expense. On the other hand, they may increase complexity and susceptibility to failure even if they only need to be simply removed, because in such cases the status of the cover must be monitored so that operation of the device is interrupted or not even started if the cover is not located in its proper position. All of this may lead to reduced efficiency of the device, as operating times are shortened and the effort for cleaning personnel is increased.

### SUMMARY

It is therefore an object of the disclosure to specify a belt conveyor device whose efficiency is improved by measures that are as simple as possible in terms of design. This object is solved by a belt conveyor device according to the disclosure.

The present disclosure describes a belt conveyor device for conveying food products, in particular dough, having a frame, a conveyor belt and a drive device configured to drive the conveyor belt. The drive device includes a drive roller configured to drive the conveyor belt, a first deflecting roller configured to guide the conveyor belt, a second deflecting roller configured to guide the conveyor belt, a first locking device configured to secure the first deflecting roller in an operating position, and a first engagement guard configured to cover a first gap between the first deflecting roller and the conveyor belt when the locking device secures the first deflecting roller in the operating position. In particular, the first locking device may be configured to hold the first engagement guard such that it covers the first gap between the first deflecting roller and the conveyor belt when the locking device secures the first deflecting roller in the operating position. Preferably, the locking device is configured to secure the first deflecting roller in an operating position and to hold a first engagement guard such that it covers a first gap between the first deflecting roller and the conveyor belt only when the locking device secures the first deflecting roller in the operating position.

The first and/or second deflecting roller may be configured to guide the conveyor belt in an operating position such that it has a higher tension than when the first and/or second deflecting roller is/are not arranged in the respective operating position. The first gap may be arranged on a side of the first deflecting roller, on which the conveyor belt runs towards the first deflecting roller during operation of the belt conveyor device. Structures that reliably prevent human body parts, in particular limbs, particularly preferably fingers, from passing may be regarded as covering the gap. It is thus conceivable that the engagement guard has openings, which are dimensioned accordingly. However, it is preferable that the engagement guard does not have any openings.

In that the engagement guard is held, preferably by the locking device, in such a way that it covers the first gap between the first deflecting roller and the conveyor belt when the locking device secures the first deflecting roller in the operating position, human body parts may be prevented from being drawn into the gap between the first deflecting roller and the conveyor belt during operation of the belt conveyor device. When the locking device is unlocked, the engagement guard may no longer be arranged to cover the first gap between the first deflecting roller and the conveyor belt. However, it then also no longer secures the first deflecting roller in the operating position. As a result, the belt tension of the conveyor belt and thus the friction as well as the clamping force between the first deflecting roller and the conveyor belt is reduced. This may reduce or eliminate the risk of human body parts being drawn into the gap between the first deflecting roller and the conveyor belt. This may allow for the elimination of monitoring, for example, electronic monitoring, thereby reducing the susceptibility to failure. In addition, the configuration described above allows two operations to be combined, thereby saving time, namely the removal of the engagement guard and the relaxation of the conveyor belt. The latter may be necessary when cleaning the belt conveyor device, as it allows cleaning of the components guiding the conveyor belt.

It may be advantageous if the first and/or the second deflecting roller is/are pivotally arranged on the frame, in particular pivotally mounted. In this way, the cleaning process may be further accelerated, since the deflecting roller, which is pivotably arranged on the frame, in particular pivotably mounted, may be held on the frame during cleaning and does not have to be stored at a parking location. This advantage may be of even greater importance, since it may be disadvantageous or even not permitted to place the deflecting roller on the floor. The drive device may, for example, include a first pivot arm. The first pivot arm may be pivotally connected to the frame. The first deflecting roller may be rotatably mounted to the pivot arm. The first locking device may be pivotally connected to the first deflecting roller. In particular, the first locking device may be pivotally disposed on the first pivot arm. The engagement guard may be movably or immovably connected to the pivot arm.

Advantageously, the belt conveyor device may further include a second locking device configured to secure the second deflecting roller in an operating position, and a second engagement guard configured to cover a second gap between the second deflecting roller and the conveyor belt when the second locking device secures the second deflecting roller in the operating position. In particular, the second locking device may be configured to hold the second engagement guard such that it covers the second gap between the second deflecting roller and the conveyor belt when the locking device secures the second deflecting roller in the operating position. The foregoing explanations relating to the first locking device, the engagement guard and the pivot arm may be analogously applicable to the second locking device and/or the second deflecting roller.

It is conceivable that the first locking device is pivotably connected to the first deflecting roller. Similarly as explained above with reference to the pivotable attachment of the first deflecting roller to the frame, a pivotable connection between the first deflecting roller and the first locking device may advantageously facilitate storage of the locking device during the cleaning process. It may be particularly advantageous if the second locking device is pivotally connected to the second deflecting roller.

It is conceivable that the first locking device may be released and/or locked by pivoting relative to the first deflecting roller. This may represent a particularly simple method of actuation. It may be particularly advantageous if the second locking device is releasable and/or lockable by pivoting relative to the second deflecting roller.

It may be advantageous if a scraper is arranged on the first locking device, which is configured to engage with the first deflecting roller. This may eliminate the need for a separate fastening device for the scraper. It may be particularly advantageous if a scraper is arranged on the second locking device, which is configured to engage with the second deflecting roller.

Advantageously, the scraper may be configured to be engaged with the deflecting roller by pivoting the locking device. This may also further simplify the cleaning process, as it may be necessary to remove a scraper that engages with the respective deflecting roller in order to clean it. In particular, if, as described further above, the first and/or second locking device may be disengaged and/or locked by pivoting relative to the first and/or second deflecting roller, further potential for accelerated operation results, since disengagement of the locking device may occur simultaneously with removal of the scraper from the respective deflecting roller.

It is conceivable that the first and second deflecting rollers are configured to tension the conveyor belt such that it wraps around the drive roller with a wrapping angle that is greater than 180°. The greater wrapping angle allows the drive force to be transferred from the drive roller to the conveyor belt more efficiently.

The belt conveyor device may further include a first holder configured to hold the first deflecting roller in a storage position. This may enable secure storage of the first deflecting roller during the cleaning process. The provision of a holder may be advantageous both in combination with a pivotable first deflecting roller, as described further above, and in combination with a non-pivotable first deflecting roller. It may be particularly advantageous if the belt conveyor device further includes a second holder configured to hold the second deflecting roller in a storage position. The first holder may be provided on the frame. In particular with a pivotable first deflecting roller, the first holder may be a device that blocks pivoting toward or too far away from the operating position, for example a hook or a stop. The explanations regarding the first holder and the first deflecting roller may be analogously applicable to the second holder and the second deflecting roller.

It is conceivable that the locking device includes a locking member, the locking device being pivotable to a locking position, in which the locking member is configured to engage with a retaining element provided on the frame. It may be particularly advantageous if the locking member is a locking bar or a hook and the retaining element is a locking bar retainer or a bolt. A locking bar or a hook may provide a particularly simple and easy to clean type of locking mechanism.

Advantageously, the locking device may be pivotable to an unlocking position, in which the locking member is configured to be guided past and/or through the retaining element.

It may be particularly advantageous if the locking device is configured such that the scraper is oriented for engagement with the deflecting roller by engagement of the locking bar with the locking bar retainer. This may expedite a start-up of the belt conveyor device after cleaning.

In embodiments having two or more locking devices and/or deflecting rollers, the above embodiments may be applicable to one, more, or all of them.

### BRIEF DESCRIPTION OF THE DRAWINGS

The disclosure relates to a belt conveyor device of the type described above. In the following, an advantageous embodiment is explained in more detail with reference to drawings.

FIG. 1 shows a perspective schematic view of a belt conveyor device;

FIG. 2 shows a schematic sectional view of a drive device of the belt conveyor device, wherein two deflecting rollers are arranged in an operating position and two corresponding locking devices are locked;

FIG. 3 shows the view from FIG. 2, with the two locking devices being unlocked;

FIG. 4 shows the view from FIGS. 2 and 3, with the deflecting rollers being arranged in a storage position; and

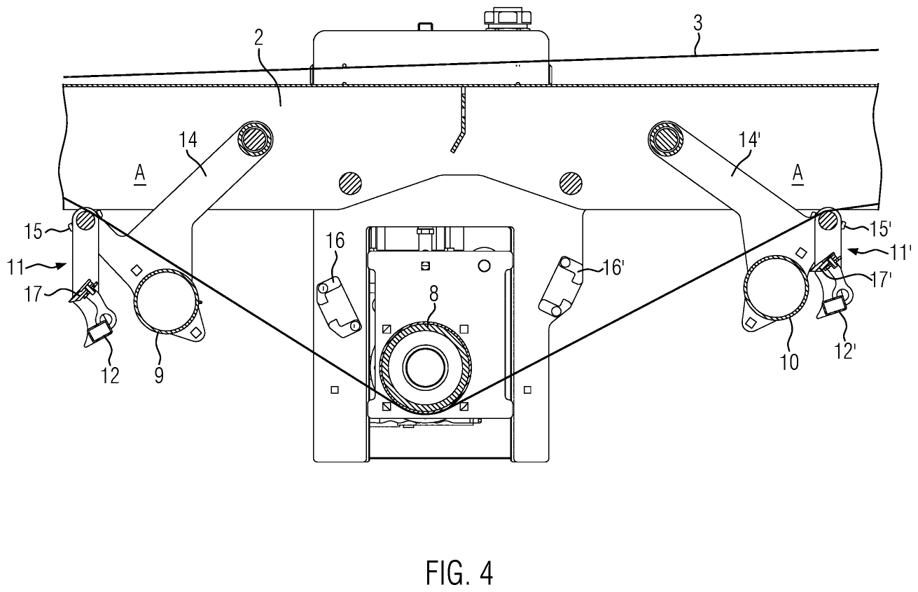

FIG. 5 shows a schematic, perspective detail view of the belt conveyor device

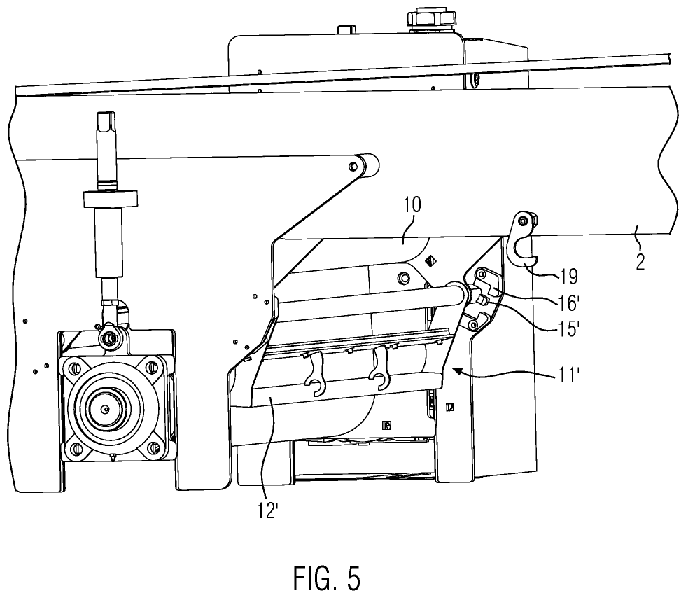

### DETAILED DESCRIPTION

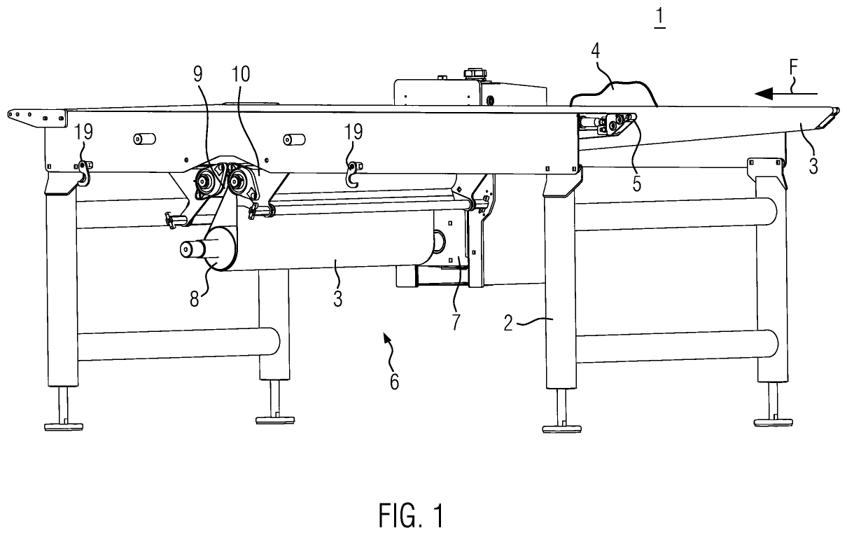

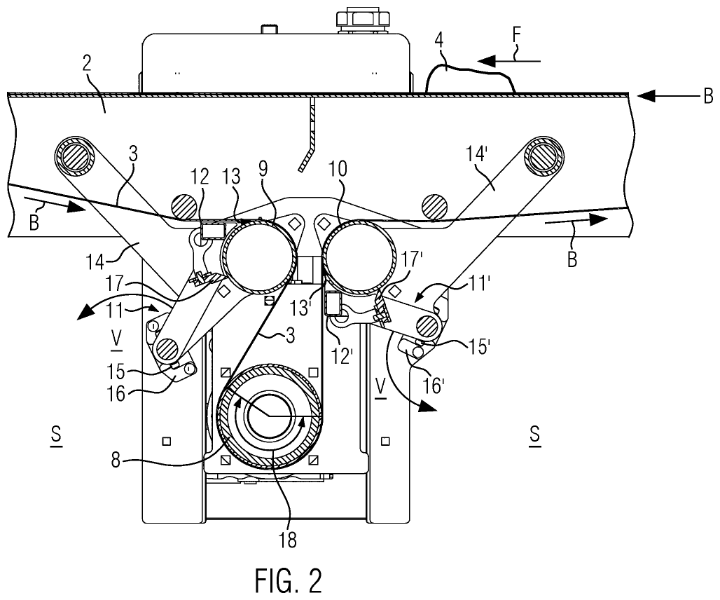

In FIG. 1, a belt conveyor device 1 is shown in a schematic, perspective view. The belt conveyor device 1 may include a frame 2. Furthermore, the belt conveyor device 1 may include a conveyor belt 3. The conveyor belt 3 may be configured to convey a food product 4, in this embodiment dough, in a conveying direction F. In doing so, the conveyor belt 3 may be guidable by various guide elements 5. The guide elements 5 may be arranged on the frame 2. The conveyor belt 3 may be moved in a belt running direction B (see FIG. 2). The belt running direction B may be oriented parallel, in particular identically, to the conveying direction F, at least in sections.

The belt conveyor device 1 may include a drive device 6. The drive device 6 may be configured to drive the conveyor belt 3. The drive device 6 may include a drive unit 7, which may for example include a motor and/or a gearbox. The drive device 6 may further include a drive roller 8. The drive unit 7 may be configured to drive the drive roller 8. The drive roller 8 may be configured to drive the conveyor belt 3. The drive device 6 may include a first deflecting roller 9. The first deflecting roller 9 may be configured to guide the conveyor belt 3. The drive device 6 may further include a second deflecting roller 10. Similarly to the first deflecting roller, the second deflecting roller 10 may be configured to guide the conveyor belt 3.

In FIG. 2, the drive device 6 is shown in a schematic sectional view. The first deflecting roller 9 and the second deflecting roller 10 are each shown in an operating position S. In FIG. 2, it is shown that the drive device 6 may have a first locking device 11. Furthermore, the drive device 6 may include a first engagement guard 12. The first engagement guard 12 may be configured to cover a first gap 13 between the conveyor belt 3 and the first deflecting roller 9. The engagement guard 12 may be arranged, in particular fixed, to the first locking device 11. The first locking device 11 may be configured to secure the first deflecting roller 9 in an operating position S, and to hold the first engagement guard 12 such that it covers the first gap 13 between the first deflecting roller 9 and the conveyor belt 3 when the first locking device 11 secures the first deflecting roller 9 in the operating position S.

The first deflecting roller 9 may be pivotally arranged on the frame 2, in particular pivotally attached to the frame 2. For this purpose, the drive device 6 may include a first pivot arm 14. The first pivot arm 14 may be pivotably connected to the frame 2. The first deflecting roller 9 may be rotatably supported on the pivot arm 14. The first locking device 11 may be pivotally connected to the first deflecting roller 9. In particular, the first locking device 11 may be pivotally disposed on the first pivot arm 14.

The first locking device 11 may include a first locking bar 15. The first locking bar 15 may be configured to engage with a first locking bar retainer 16. The first locking bar retainer 16 may be provided on the frame 2. In FIG. 2, the first locking device 11 is shown in a locking position V. In the locking position V, the first locking bar 15 may engage with the first locking bar retainer 16 such that the locking device 11 is retained in the locking position V. In the locking position V, the first locking device 11 may secure the first deflecting roller 9 in the operating position S. By pivoting the locking device 11 out of the locking position V, the engagement between the first locking bar 15 and the first locking bar retainer 16 may be released, whereby the first locking device 11 may also be released from the locking position V.

Furthermore, as can be seen in FIG. 2, the drive device 6 may include a first scraper 17. The first scraper 17 may be arranged on the first locking device 11. The first scraper 17 may be configured to engage with the first deflecting roller 9. A person skilled in the art will recognize from the drawings that the first scraper 17 may be configured to be brought into engagement with the first deflecting roller 9 by pivoting the first locking device 11. It can further be seen that the first locking device 11 may be configured such that by engagement of the first locking bar 15 with the first locking bar retainer 16, the first scraper 17 is oriented for engagement with the first deflecting roller 9.

In FIG. 2, it may also be seen that the drive device 6 may include a second locking device 11′ in addition to the first locking device 11. Furthermore, the drive device 6 may include a second engagement guard 12′. The second engagement guard 12′ may be arranged to cover a second gap 13′ between the conveyor belt 3 and the second deflecting roller 10. The engagement guard 12′ may be arranged, in particular fastened, to the second locking device 11′. The second locking device 11′ may be configured to secure the second deflecting roller 10 in an operating position S, and to hold the second engagement guard 12′ such that it covers the second gap 13′ between the second deflecting roller 10 and the conveyor belt 3 when the second locking device 11′ secures the second deflecting roller 10 in the operating position S.

Similarly to the first deflecting roller 9, the second deflecting roller 10 may be pivotally arranged on the frame 2, in particular pivotally attached to the frame 2. For this purpose, the drive device 6 may include a second pivot arm 14′. The second pivot arm 14′ may be pivotably connected to the frame 2. The second deflecting roller 10 may be rotatably supported on the pivot arm 14′. The second locking device 11′ may be pivotally connected to the second deflecting roller 10. In particular, the second locking device 11′ may be pivotally disposed on the second pivot arm 14′.

The second locking device 11′ may include a second locking bar 15′. The second locking bar 15′ may be configured to engage with a second locking bar retainer 16′. The second locking bar retainer 16′ may be provided on the frame 2. In FIG. 2, the second locking device 11′ is shown in a locking position V. In the locking position V, the second locking bar 15′ may engage with the second locking bar retainer 16′ such that the locking device 11′ is retained in the locking position V. In the locking position V, the second locking device 11′ may secure the second deflecting roller 10 in the operating position S. By pivoting the locking device 11′ out of the locking position V, the engagement between the second locking bar 15′ and the second locking bar retainer 16′ may be released, thereby also releasing the second locking device 11′ from the locking position V.

Furthermore, it may be seen in FIG. 2 that the drive device 6 may include a second scraper 17′. The second scraper 17′ may be arranged on the second locking device 11′. The second scraper 17′ may be configured to engage with the second deflecting roller 10. A person skilled in the art will recognize from the drawings that the second scraper 17′ may be configured to be brought into engagement with the second deflecting roller 10 by pivoting the second locking device 11′. It can further be seen that the second locking device 11′ may be configured such that by engagement of the second locking bar 15′ with the second locking bar retainer 16′, the second scraper 17′ is oriented for engagement with the second deflecting roller 10.

Furthermore, it can be seen from FIG. 2 that the first deflecting roller 9 and the second deflecting roller 10 are configured to tension the conveyor belt 3 such that it wraps around the drive roller 8 at a predetermined wrapping angle 18. As shown here in the embodiment explained with reference to FIG. 2, the wrapping angle 18 may be greater than 180°.

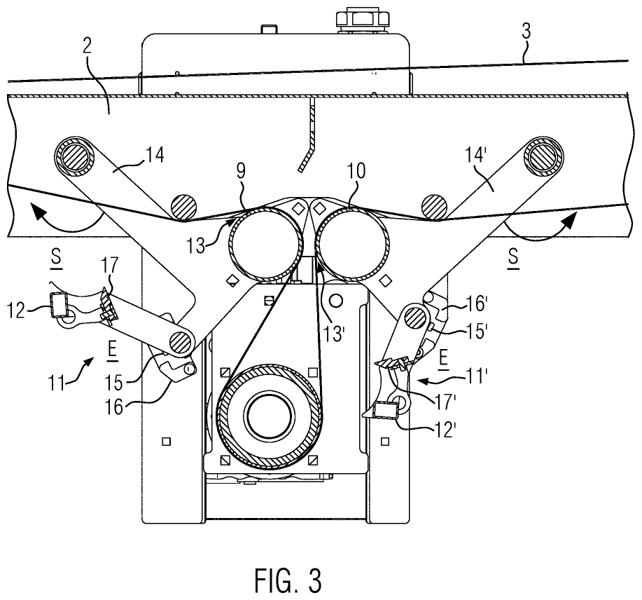

In FIG. 3, a sectional view of the drive device 6 is shown from the same perspective as in FIG. 2. The first locking device 11 and the second locking device 11′ are each shown in an unlocking position E. In the unlocking position E shown, the first locking bar 15 and/or the second locking bar 15′ may be configured to pass by and/or through the first locking bar retainer 16 and the second locking bar retainer 16′. This may enable the first deflecting roller 9 and/or the second deflecting roller 10 to be pivoted out of the operating position S, in which both deflecting rollers are still shown in FIG. 3.

After the first deflecting roller 9 and the second deflecting roller 10 have been pivoted out of the respective operating position S, both of them or only one of them may each be stored in a storage position A. Holders 19 may be arranged on the frame 2. The holders 19 may be configured to hold the first deflecting roller 9 and/or the second deflecting roller 10 in the storage position A.

What is claimed is:

1. A belt conveyor device for conveying food products comprising:
a frame;
a conveyor belt; and
a drive device configured to drive the conveyor belt, wherein the drive device comprises:
a drive roller configured to drive the conveyor belt;
a first deflecting roller configured to guide the conveyor belt;
a second deflecting roller configured to guide the conveyor belt;
a first locking device configured to secure the first deflecting roller in an operating position; and
a first engagement guard configured to cover a first gap between the first deflecting roller and the conveyor belt when the first locking device secures the first deflecting roller in the operating position.

2. The belt conveyor device according to claim 1, wherein the first and/or the second deflecting roller are/is pivotably arranged on the frame.

3. The belt conveyor device according to claim 1, further comprising a second locking device configured to secure the second deflecting roller in an operating position, and a second engagement guard configured to cover a second gap between the second deflecting roller and the conveyor belt when the second locking device secures the second deflecting roller in the operating position.

4. The belt conveyor device according to claim 3, wherein the first locking device is pivotally connected to the first deflecting roller and/or the second locking device is pivotally connected to the second deflecting roller.

5. The belt conveyor device according to claim 3, wherein the first locking device is releasable and/or lockable by pivoting relative to the first deflecting roller, and/or the second locking device is releasable and/or lockable by pivoting relative to the second deflecting roller.

6. The belt conveyor device according to claim 3, wherein a scraper is arranged on the first locking device or the second locking device, and the scraper is configured to engage with the first deflecting roller or the second deflecting roller.

7. The belt conveyor device according to claim 6, wherein the scraper is configured to be engaged with the first deflecting roller or the second deflecting roller by pivoting the first locking device or the second locking device.

8. The belt conveyor device according to claim 3, wherein a first scraper is arranged on the first locking device and is configured to engage with the first deflecting roller, and a second scraper is arranged on the second locking device and is configured to engage with the second deflecting roller.

9. The belt conveyor device according to claim 3, wherein the first or the second locking device comprises a locking member, wherein the first or the second locking device is pivotable to a locking position, in which the locking member is configured to engage with a retaining element provided on the frame.

10. The belt conveyor device according to claim 9, wherein the locking member comprises a locking bar and the retaining element comprises a locking bar retainer.

11. The belt conveyor device according to claim 9, wherein the first or the second locking device is positionable into an unlocking position by pivoting, in which the locking member is configured to be guided past and/or through the retaining element.

12. The belt conveyor device according to claim 3, wherein the first locking device comprises a first locking member, the second locking device comprises a second locking member, the first locking device is pivotable to a locking position in which the first locking member is configured to engage with a first retaining element provided on the frame, and the second locking device is pivotable to a locking position in which the second locking member is configured to engage with a second retaining element provided on the frame.

13. The belt conveyor device according to claim 1, wherein the first and second deflecting rollers are configured to tension the conveyor belt such that it wraps around the drive roller with a wrapping angle that is greater than 180°.

14. The belt conveyor device according to claim 1, further comprising a holder configured to hold the first deflecting roller in a storage position.

15. The belt conveyor device according to claim 1, wherein the first locking device comprises a locking bar, the frame comprises a locking bar retainer, a scraper is arranged on the first locking device, the first locking device is pivotable to a locking position in which the locking bar is configured to engage with the locking bar retainer, and the scraper is oriented for engagement with the first deflecting roller by engagement of the locking bar with the locking bar retainer.
